(19) United States
(12) Patent Application Publication
(10) Pub. No.: US 2012/0247959 A1
(43) Pub. Date: Oct. 4, 2012

(54) THROUGH-FLOW CAPACITIVE DEIONIZATION CELL

(75) Inventors: Leonard Paul Seed, Guelph (CA); Iurie Pargaru, Guelph (CA); Gene Sidney Shelp, Guelph (CA)

(73) Assignee: ENPAR TECHNOLOGIES INC, GUELPH (CA)

(21) Appl. No.: 13/515,606

(22) PCT Filed: Dec. 16, 2010
(86) PCT No.: PCT/CA10/02062

§ 371 Date: Jun. 13, 2012

(30) Foreign Application Priority Data
Dec. 16, 2009 (GB) 0921953.6

(51) Int. Cl. B03C 5/02; C02F 1/469; B03C 5/00

(52) U.S. Cl. 204/554; 204/674; 204/671

(57) ABSTRACT

The capacitive electrodes of the CDI cell are arranged to form a tube. Water to be treated flows through the tube-walls. The CDI electrodes are permeable, and form the tube-walls, whereby the flow passes through the thicknesses of the electrodes and of the spacers. The electrodes may be in the form of concentric tubes, or may be wrapped spirally.

This technology relates to capacitive deionization (CDI). In a CDI cell, water containing ions of a contaminant (e.g sodium chloride) is passed between the plates of a capacitor.

### BACKGROUND

In a CDI cell, the water to be purified passes between positively and negatively charged electrodes. When the CDI cell is operated in its purification phase, electrostatic charges on the electrodes (plates) attract respective dissolved ions, whereby the ions are adsorbed out of the passing water and onto the plates. The value-water now leaving the cell is deionized and purified.

When the CDI cell is operated in its regeneration phase, the electrostatic charges on the plates are reversed (or, preferably, the plates are electrically shorted), whereby the no-longer-attracted ions leave the plates, and enter the passing regen-water. Now, the regen-water leaving the cell contains the contaminant ions—usually at a (much) heavier concentration than in the incoming water.

In CDI, the contaminant is not broken down. Rather, in CDI, the contaminant ions are captured and stored by and in the electrodes, and are thereby removed from the purification-phase effluent (the value-water). Later, the concentrated contaminant ions are released into the regeneration-phase effluent (the regen-water), where the contaminant remains, still intact, and awaiting disposal.

In CDI, the electrodes are charged and discharged in the usual manner of a capacitor. The purification-phase of the operation of a CDI cell coincides with charging the capacitor. The regeneration-phase coincides with discharging the capacitor. In order to effect an operational change from the regeneration-phase to the purification-phase, the CDI electrodes are electrically energized, and at the same time the flow of effluent (the purified value-water) is re-routed into a holding tank, ready for use, or for sale, or for further treatment, or etc. To effect an operational change from the purification-phase to the regeneration-phase, the CDI electrodes are electrically reversed or shorted, and at the same time the flow of effluent (the concentratedly-contaminated regen-water) is re-routed away for disposal.

In CDI, the voltage applied to the electrodes is of sufficient magnitude that the cell acquires a substantial capacitive charge. When charging, at first a spike of current occurs in the charging circuit, and then the current gradually decays (to zero, or almost zero) as the plates approach their full charge, and as the plates become coated with ions adsorbed out of solution in the water.

Similarly during regeneration of the CDI cell; when the plates are shorted, at first there is a spike of current (of opposite polarity, of course) in the circuit, and then the current gradually decays to zero as all the charge is dissipated, and as all the ions disappear from the capacitor plates, and enter the regen-water.

In CDI, the voltage applied to the electrodes remains below the magnitude at which electrolysis of the water takes place, or might take place. In CDI, the water does not undergo redox breakdown reactions. (By contrast, electrolysis typically does involve redox transformation reactions.) In CDI, during purification, the ions are adsorbed out of solution, into the electrodes, and the ions are physically retained in the electrodes solely by electrostatic attractive forces.

The present technology follows these same principles of capacitive deionization.

The expressions anode and cathode are used herein, sometimes, to refer to the positively and negatively charged plates of the capacitor. The use of these terms does not imply that electrochemical redox reactions and transformations are taking place at the electrodes. In a CDI cell, the ions are simply attracted to the electrodes by electrostatic attraction, and remain intact, and sorbed into the electrodes, until released during regeneration.

### SOME FEATURES OF THE INVENTION IN RELATION TO THE PRIOR ART

In conventional CDI cells, a major component of the velocity of the water being treated is directed along the space between the electrodes or plates. That is to say, the water moves in a direction parallel to the plane of the plates.

In patent publication ppp, for example, the electrodes, and the dielectric spacers between the electrodes, are flat, and the water flows along and through the spacers, in the direction parallel to the plane of the flat plates. In U.S. Pat. No. 5,547,581, being another example, the electrodes and the spacers are wrapped into a spiral curve; now, the water flows in the spiral direction along and through the spacers that hold the electrodes apart. In these examples, the water being deionized flows through and along the spacers located between the electrodes.

By contrast, in the present technology, the water being deionized flows through the thickness of the electrodes. That is to say, at least a predominant component of the velocity of the water being deionized, as it passes through the CDI cell, is normal or perpendicular to the plane of the electrodes and of the spacers between the electrodes.

In the present technology, in order for the water to pass thickness-wise through the electrodes, and through the spacers, of course the electrodes and spacers must be substantially permeable to the through-flow of the water. (This may be compared with the conventional CDI cells, where the water flows along and between the electrodes—whereby it was immaterial whether the electrodes were themselves through-permeable.)

### DETAILED DESCRIPTION OF PREFERRED EMBODIMENTS

The technology will now be further described with reference to the accompanying drawings, in which:

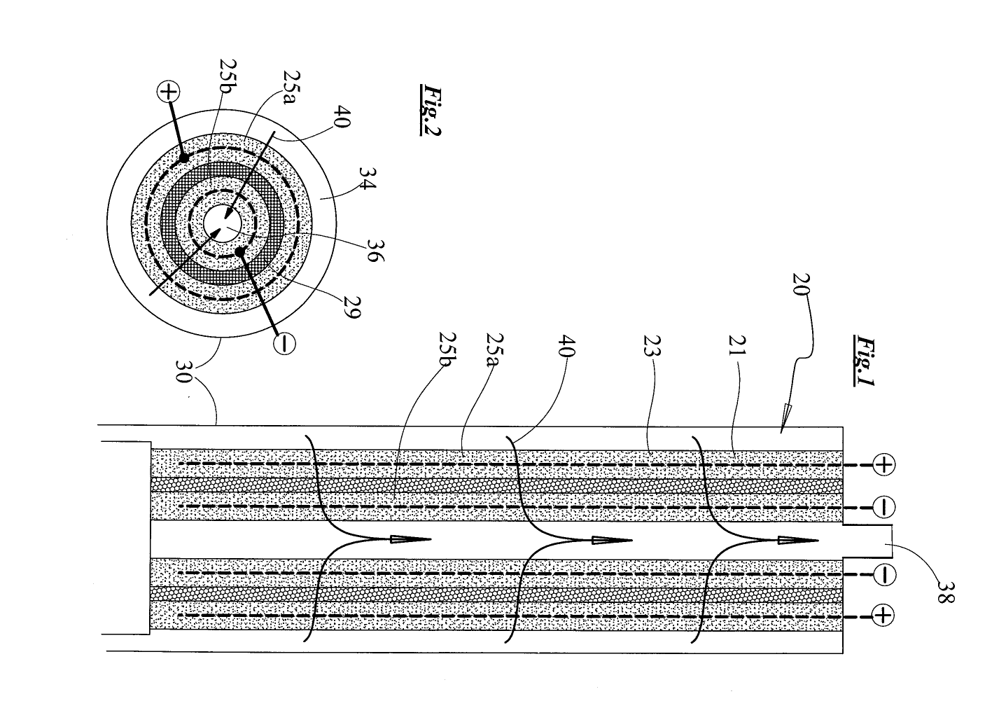

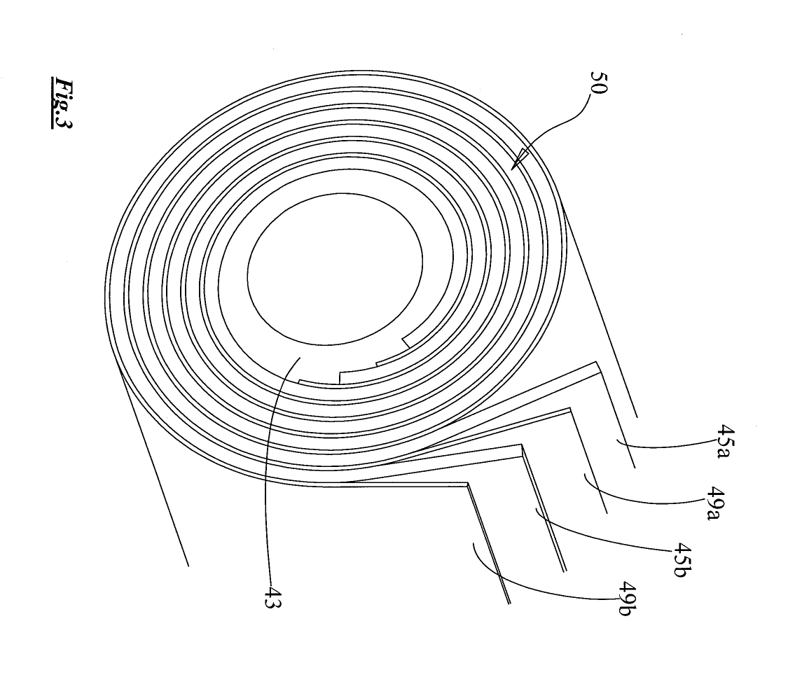

FIG. 1 is a diagrammatic side-view, in cross-section, and FIG. 2 is a diagrammatic end-view, of parts of some components of a water treatment apparatus.

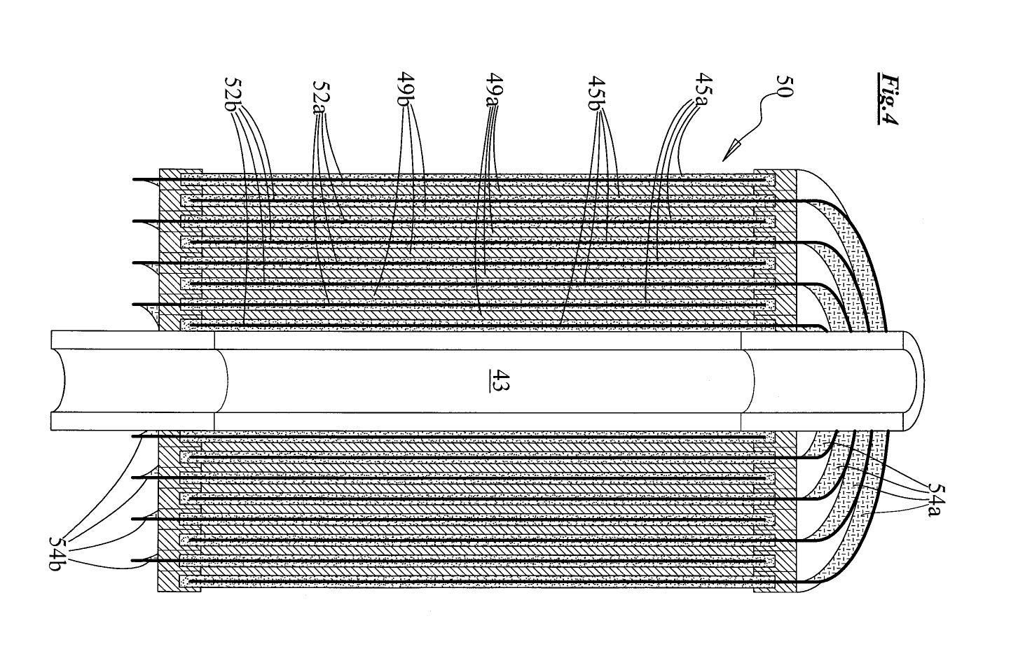

FIG. 3 is a pictorial view of a sub-assembly of two electrodes wrapped spirally around a tube-former.

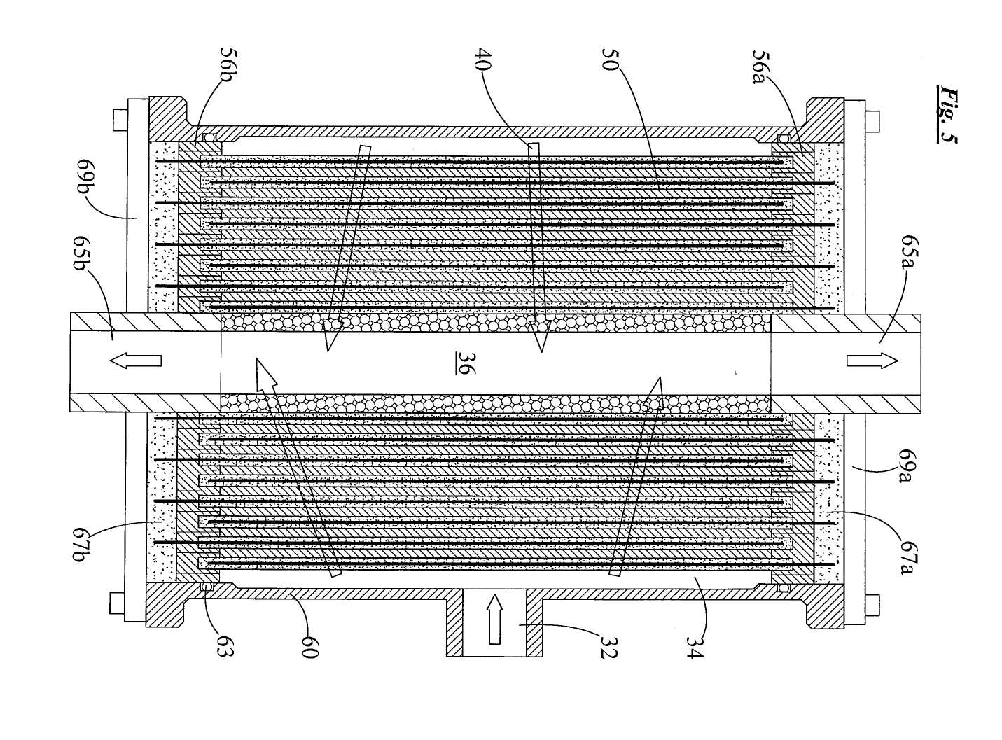

FIG. 4 is a sectioned side view of the sub-assembly of FIG. 3.

FIG. 5 shows the sub-assembly of FIG. 4 assembled into a canister, and in operation to remove ions from water.

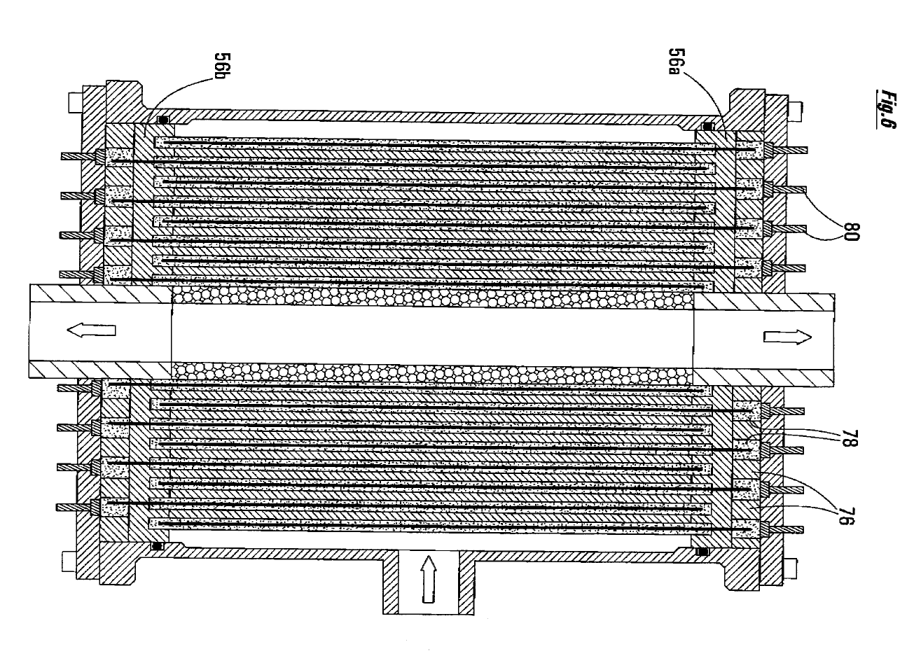

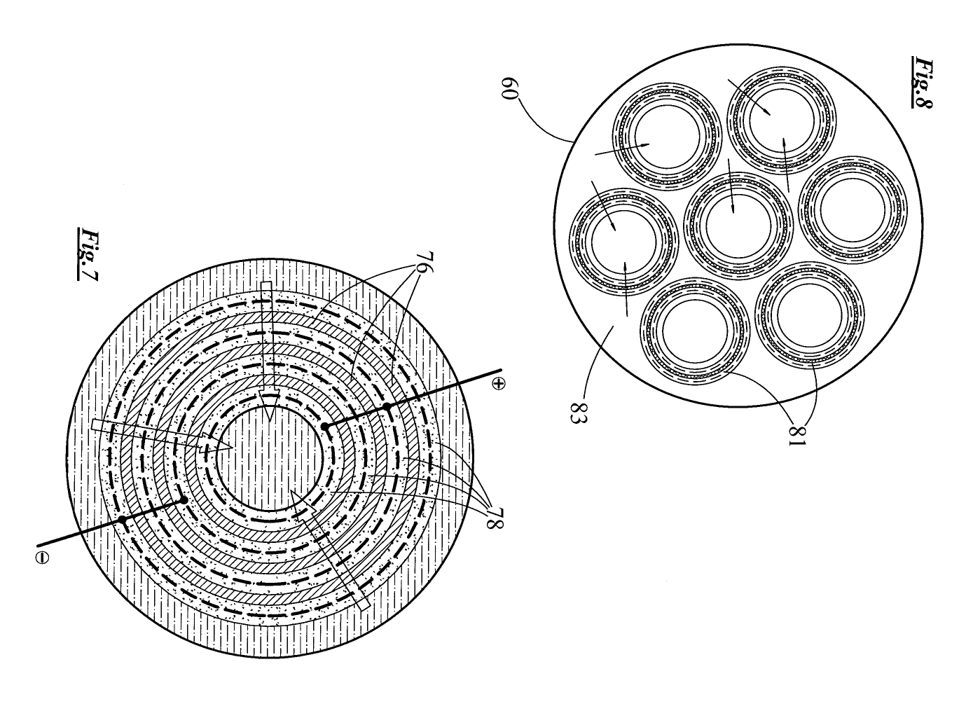

FIG. 6 is a diagrammatic side-section, and FIG. 7 is a diagrammatic end-section, of another apparatus, in which the many electrodes are in the form of concentric tubes.

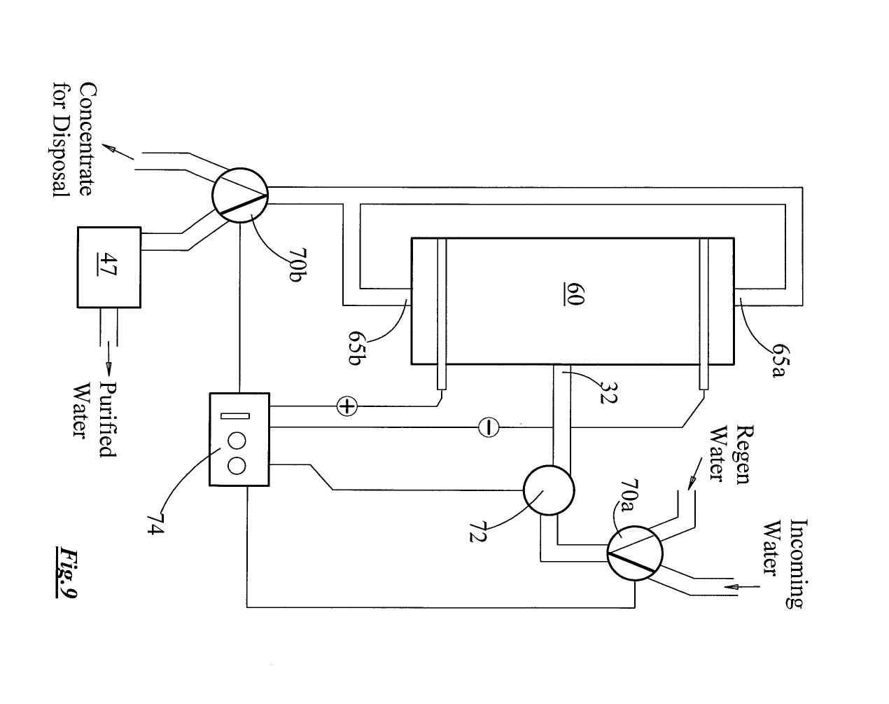

FIG. 8 is a sectioned plan view of another treatment apparatus, that includes several smaller treatment-tubes.

FIG. 9 is a diagram illustrating some of the hydraulic and electrical connections used in the apparatus.

In the drawings, the apparatus 20 includes a treatment-tube 21, having cylindrical tube-walls 23. The tube-walls 23 are composite in structure, comprising an outer electrode 25a and an inner electrode 25b, and a spacer 29 between the electrodes.

The tube 21 is housed in a plastic container 30. Contaminated water to be purified is introduced into an inlet port 32, and enters an annular outer-plenum 34. The water passes radially inwards, through the thickness of the outer-electrode 25a, through the thickness of the spacer 29, through the thickness of the inner-electrode 25b, and collects in an inner-plenum 36. From there, the now-purified effluent water passes out through an outlet-port 38. Arrows 40 indicate the movement of the water.

The material of the electrodes 25a, 25b is porous and permeable and hydrophillic. The material is also electrically-conductive. The material of the spacer 29 is permeable, hydrophillic, and is electronically non-conductive.

The electrodes 25a, 25b and spacer 29, and the treatment-tube 21 formed therefrom, are so engineered as to form the plates of a capacitor. The material of the electrodes 25a, 25b is activated carbon. Activated carbon has a very large capacitive-surface-area; typically, the capacitive-surface-area is 500 sq.metres, or more, per gram of the material. For present purposes, a material would be regarded as not porous enough, if its capacitive-surface-area were less than 100 sq.m per gram.

(The capacitive-surface-area of the electrode is the area that is effectively available to receive ions sorbed out of the passing water. This area is contrasted with the simple projected-area of the electrode.)

The electrodes 25a, 25b are in the form of respective sheets or films of activated carbon, each having a thickness, measured radially with respect to the axis of the treatment-tube 21, of no more than 500 microns.

The permeability of the electrode is one of the parameters of the CDI cell that determines the performance of the cell, from the standpoint of deionizing the water. The permeability of the cell would be too low if the hydraulic pressure then needed to drive the water through the cell were so high as to cause engineering problems in the cell. The intrinsic permeability of the electrodes should be no more than about one darcy.

As mentioned, the designers will usually arrange for the water to pass through several pairs of electrodes, preferably in the sequence: anode-spacer-cathode-spacer-anode-spacer-cathode-spacer-anode and so on. Each spacer 29 is in the form of a thin sheet or film. (The thicknesses of the thin components are much exaggerated in the drawings.)

The spacers 29 are made of insulative material, such as polyethylene (treated to be hydrophillic), or polyester, or other chemically-stable porous permeable polymer. The spacer material is electrically non-conductive, i.e it cannot conduct ions; however, an ionically conductive polymer (e.g a grafted polysulfone material) could be used as the spacer material.

Each spacer should be thin, to enable the electrodes to be in close-spaced adjacency to each other. Generally, the thinner the spacer, the better the capacitive performance. Preferably, the spacer should not be more than 100 microns thick. If the spacer were more than 250 microns in thickness, that would be an indication that no attempt was being made to make the spacer thin.

The spacer 29 should be more permeable than the electrodes 25a, 25b. The smaller the resistance to liquid flow attributable to the spacer, the better. Preferably, the darcy permeability of the spacer should be at least double that of the electrodes.

In the conventional CDI technology, where the water undergoing treatment passes through and along the space between (i.e parallel to) the electrodes, the electrode plates had to be well-spaced apart, in order to permit the required liquid flow-rate. Equally, the material of the spacer, in the conventional CDI cell, had to be as permeable as possible. In the present technology, now the water undergoing treatment passes through the thickness of the (permeable) electrode.

Because the water flows through the electrodes, and through the spacer, rather than along the faces of the electrodes, therefore the space between the electrodes can be narrower than in the conventional cells. The limitation as to the minimum thickness of the spacer is now determined simply by the need for mechanical robustness, rather than by a need for the spacer to be permeable enough to conduct a longitudinal flow of water.

A spacer in the form of an electrically-insulative, very permeable, film or sheet, should, for the said robustness reasons, be at least twenty-five microns thick. Alternatively, the permeable dielectric spacer can be bonded to, or otherwise integrated into the structure of, the electrode. In that case, the spacer is physically supported, as a structure, by the electrode itself, whereby the spacer can be even thinner.

Another benefit that arises from the feature of conducting the water to be treated through the thicknesses of the electrode plates in the direction normal to the plane of the electrodes, rather than through and along the space between the electrode plates in the direction parallel to the plane of the electrodes, may be described as follows.

When the CDI cell is being operated in its purification phase, ions of the dissolved contaminants are attracted out of the passing water, and are sorbed onto the respective electrodes. As the plates approach full charge, so the plates become saturated with the adsorbed ions. In CDI, these ions have to be removed from the plates during the regeneration phase.

In the conventional CDI cells, problems could arise during regeneration. It was desired, during regeneration, that the polarity of the electricity supplied to the electrodes should be reversed, whereby the ions would now be repelled from the electrodes, as an aid to their entering the regen-water. But of course, the repelled ions would now be simply attracted to the adjacent now-oppositely-charged electrode. Therefore, in the conventional CDI cells, in order to permit or enable the polarity of the electrodes to be reversed during regeneration, it was necessary to provide charge-barriers. These charge-barriers were placed over the electrodes, and were so structured and arranged that, during the purification-phase, the charge-barriers did not interfere with the entry of the ions into the electrodes to which the ions were, at this time, attracted. But then, during regen, when the electrode polarities were reversed, now the charge-barriers did prevent the ions entering the electrodes to which the ions were now attracted.

It was not good enough, in the conventional CDI cells, for the electrodes to be simply electrically-shorted together during the regen-phase. If the electrodes were merely shorted, electrostatic repulsion was not available, and the only available force driving the ions to enter the regen-water was diffusion—which was slow and inefficient. Reversing the polarity of the electrodes, actually to repel the ions, made the regen-phase more efficient. Thus, commercial conventional CDI cells have generally been provided with charge-barriers.

But charge-barriers do somewhat impede the transfer movement of the ions between the passing water and the electrodes, both during the purification-phase and in the regeneration-phase. Plus, charge-barriers added to the complexity and expense of the CDI cell.

In the present technology, charge-barriers are not required. Here, during the regen-phase, the electrodes are simply shorted together, but now, since the movement of the water is through the thickness of the electrodes, the moving water provides a flushing-out effect, whereby the ions are physically transferred into the passing regen-water. Thus, regeneration is fast and efficient.

In the present technology, the electrodes act as a physical filter. The water passes through the material of the electrodes, and therefore the material cannot avoid serving as a filter for removing suspended solid particles. Water to be treated in the present CDI cell preferably should be thoroughly filtered, prior to being passed through the cell. Filtration of suspended solids down to five microns or less, is preferred. Thus, if the water being treated contains quantities of very fine solid particles, commercial use of the present technology would be contra-indicated.

As mentioned, in the present technology, the water being purified passes through the thickness of the electrodes. Preferably, the velocity of the passing water is normal to the plane of the electrodes. It should not be understood, however, that there cannot be any component of velocity of the water in the direction parallel to the plane of the electrodes. Rather, the emphasis is that during treatment, the water might have a minor component of velocity in the direction parallel to the plane of the electrode plates when passing through the electrodes, but the major component of water velocity should be normal to the plane of the electrodes.

(It will be understood that the plane of the electrodes is not necessarily a flat plane, and indeed in the preferred embodiments it is a cylindrical or spiral plane. But at any locality of the area of the electrode, the major component of velocity should be normal to the plane of the electrodes at that locality.)

In FIG. 3, two electrodes 45a, 45b are provided, and two spacers 49a, 49b, the sub-assembly 50 being wrapped spirally about a tube-former 43. Generally, when the present technology is used, it is preferred to pass the water, not through just one pair of electrodes, as in FIGS. 1, 2, but, though many pairs (and many spacers). In a commercial apparatus based on spirally-wrapped electrodes, ten turns or more would be typical. Each turn of the spiral represents one pair of electrodes to be traversed by the water being treated, as it passes radially inwards through the permeable tube-walls created by the electrodes.

FIG. 4 shows four turns of the sub-assembly 50 of spirally-wrapped electrodes. All the anodes are connected together electrically, by virtue of existing all in the same piece of material. An electrical connection to one anode necessarily connects to all the other anodes. (Likewise, all the cathodes). Thus, in a spiral-wrap sub-assembly, the many anodes are connected electrically in-parallel, whereas the water flows through the many electrode pairs hydraulically in-series.

The manner in which the axial ends of the spiral-wrap sub-assembly 50 are processed may be described as follows. Each electrode 45a, 45b has embedded in it respective current-collectors 52a, 52b. The current-collector is a metal, being a metal that has good electrical conductivity, and being a metal that is substantially inert in water, and inert with respect to the contaminants likely to be encountered in the water being processed. Typically, titanium is the metal selected for the purpose. (The current-collectors are not shown in FIG. 3.)

The current-collector 52a, 52b is in the form of a mesh, arranged so as to pose little or no hindrance to the flow of water through the thickness of the electrode 45a, 45b. The current-collector 52a, 52b is of lower electrical resistance than the activated-carbon material of the electrode 45a, 45b, and serves to even out any gradients or differences of voltage that might tend to be present in different localities of the projected area of the electrode.

A portion 54a of the current-collector 52a protrudes upwards from the axial edge of the spiral electrode 45a, as shown in FIG. 4. Likewise, a portion 54b of the current-collector 52b protrudes downwards from the axial edge of the electrode 45b.

Prior to the act of spirally wrapping the electrodes, an uncured bead of (insulative) epoxy resin or other potting material is applied to the axial ends or edges of the sheets of activated-carbon material that will form the electrodes 45a, 45b. The bead overlies the edge of the activated-carbon material of the electrode, but the current-collector 52a, 52b protrudes through the bead. The two insulative spacers 49 that separate the electrodes are assembled so as to lie between the electrodes, as shown in FIG. 3. The procedure of wrapping is now commenced. The spacers 49 are of a smaller axial width than the electrodes 45a, 45b, and the act of wrapping causes the (soft and pliable) material of the beads to fill any voids between electrodes and the spacers at the edges thereof.

The wrapping operation is done in such manner that the resulting spiral is tight, leaving substantially no trapped air or voids in the sub-assembly, and also, of course, so that the material of one electrode cannot touch the other. The operation is done in such manner that, after wrapping, and after the potting material of the beads has cured and set hard, the beads combine, and take the form of insulative caps 56a, 56b, one at each axial end of the spiral-wrap sub-assembly 50. Again, the current-collectors 52a, 52b protrude through the caps, one 52a through the upper-cap 56a, and the other 52b through the lower-cap 56b.

The loose outer circumferential ends of the electrodes and spacers of the spiral-wrap sub-assembly should be taped down, or otherwise secured, after wrapping (and before curing of the beads). It may be noted that, when spiral wrapping has been done in the previous conventional CDI cells, the water has been conducted between the electrodes in the spiral direction; therefore, access had to be provided for the water to enter the outer circumferential ends of the spacers. By contrast, in the present technology, there is no need to keep the outer circumferential ends of the spacers open, because now the water passes thickness-wise through the thickness of the (permeable) electrode sheet, rather than spiral-wise through the spacers. The elimination of the need to keep the ends of the spacers open and free to receive incoming water, now simplifies the operation of fixing those ends after wrapping.

In FIG. 5, the spiral-wrap sub-assembly 50 has been placed in a housing in the form of canister 60. The caps 56a, 56b, having now hardened, can be formed or machined to be a sliding fit inside the internal chamber of the canister 60, and to make a seal with the O-rings 63.

With the sub-assembly 50 positioned inside the canister 60, more potting material—this one having electrically-conductive properties—is applied so as to encase the protruding portion 54a of the current-collector 52a of the electrode 45a. This material hardens to form an upper conductive-cap 67a. A cover-plate 69a closes the upper end of the canister 60.

Likewise, a lower conductive cap 67b pots the protruding portion 54b, and cover-plate 69b closes the lower end of the canister 60.

Water to be treated enters the inlet port 32, and passes into the annular outer-plenum 34. The water then passes through the spiral-wound stack of electrode-pairs, being the sub-assembly 50. The arrows 40 show the water passing through the thicknesses of the material of the electrodes, and of the spacers 49.

End-portions of the tube-former 43 serve as outlet ports 38, to connect the inner-plenum 36 to the hydraulic circuit by which the water treatment is operated. The end-portions, like the canister 60, are of impermeable, insulative material. The middle portion of the tube-former 43 is permeable and insulative.

The water passes through the permeable middle-portion of the tube-former 43, and emerges into the inner-plenum 36, from which the (now-purified) water exits, via the outlet-ports 38.

During the purification-phase, a DC voltage is applied to the electrodes. As in conventional CDI treatment, the voltage is set to a level that is high enough to create a substantive capacitive effect, but yet which is low enough not to trigger any substantial redox transformation reactions involving the dissolved ions, nor involving the water.

The highest voltage at which the particular pair of electrodes can be operated, without triggering substantial redox reactions, with particular contaminants in the water, can quickly be determined by trial and error. Typically, a voltage of 1.6 volts would be as high as the operators would go, while allowing a reasonable margin of tolerance, if the conditions of operation were to favour the use of the highest charge-voltage. If the conditions allow only the lowest voltage, typically that would be 1.2 volts.

FIG. 9 is a diagram of the hydraulic circuit and associated components of the water treatment apparatus. As shown, the flow-control valves 70a, 70b are set for the purification phase of operation of the apparatus. Here, water is pressurized by the pump 72, and enters the canister housing 60. Purified water (being the value-water, i.e the commercial product produced by the apparatus) enters a storage tank 47, ready for sale.

An electrical controller 74 supplies DC electricity, at the appropriate voltage, to the electrodes inside the canister 60. The controller also operates the pump 72, and operates the flow-control valves 70a, 70b.

In order to switch the apparatus to the regeneration-phase, the controller 74 shorts the two electrodes together, and flips the valves over. Now, the regen-water is pumped through the canister, and the now-concentrated effluent is piped away for disposal.

The trigger by which the controller changes the apparatus from purification to regeneration should be coordinated with the charging of the capacitor. The rate at which the capacitor charges and discharges is determined by the number of ions already sorbed into, or still remaining in, the electrodes. Thus, the changeover-trigger may be activated by sensing the state of charge/discharge of the capacitor, in which the change from purification to regeneration is effected when the capacitor reaches, or nearly reaches, full charge; likewise, the change from regeneration to purification is effected when the capacitor reaches, or nearly reaches, full discharge. However, once the cell is in CDI operation, the timing of the changeover can be effected accurately enough, often, by the use of a simple timer.

In a commercial operation, the purification-phase typically lasts for several minutes, and the regen-phase for e.g one or two minutes. One desire the designers have is to reduce the time of the regen-phase, since that represents inefficiency.

Often, the regen-water can be the same water as the incoming water; in that case, the valve 70a is not required. (The regen-phase of the operation can be effective to raise the salt concentration in the water to e.g 10%. The incoming water (being, typically, at less than 1% salt), as regen-water, will accept the extra salt concentration almost as easily as if the regen-water were fresh water.)

In an alternative arrangement, in the regen-phase, the incoming regen-water is routed into the inner-plenum and flows radially outwards through the electrodes and spacers. If all the electrodes were of the same capacitive-area, then, during the purification-phase, as the water from which the salt ions are to be removed travels through the electrodes radially inwards through the walls of the treatment-tube; during the regen-phase, the regen-water, which receives the salt ions released from the electrodes, travels radially outwards through the walls of the treatment-tube.

The benefits of this arrangement may be explained as follows. During purification, the rate at which ions are taken out of solution depends on the concentration of ions in the (aqueous) solution. The concentration diminishes as the water travels inwards through the walls of the treatment-tube. So, if all the electrodes were of the same capacitive-area, then, as the contaminated water passed through the thicknesses of the electrodes, the number of cations sorbed into the upstream cathodes would be considerably larger than the number of cations sorbed into the downstream cathodes.

Additionally, it is also the case, during the purification-phase, that, for a given voltage, the rate at which electrons flow into (out of) a sq.cm of projected area of an anode (cathode) is inversely proportional to the number of ions already sorbed onto that particular sq.cm of that particular anode (cathode).

Both of these effects suggest that, during the purification-phase, in the interests of efficiency, in a CDI cell with through-the-thickness water flow, the projected surface area (and likewise the capacitive-surface-area) of succeeding electrodes should decrease, in the direction of the flow of water. Given the tube-wall configuration of the present technology, simple geometry dictates that the number of sq.cm of innermost-electrode-surface is smaller than the number of sq.cm of outermost-electrode-surface. Thus, the tube configuration enables makes it easier for the designers to approach the ideal of the same number of sorbed ions per sq.m of capacitive-surface-area throughout all the electrodes.

During the regen-phase, similar comments can be made about the rate at which the ions are released from the electrodes, into the regen-water. The rate at which ions leave a sq.cm of the electrodes, and enter the regen-water, is proportional to the number of ions in that sq.cm. Most of the sorbed ions are lodged in the outermost electrodes, and, since the ions, once released, have to travel through the thicknesses of all the downstream electrodes, the water should pass outwards, i.e through the outer-electrodes last.

These effects can cancel each other out (i.e can tend to make it not matter whether the regen-water flows inwards or outwards). However, outwards flow is considered to be more likely to be more efficient, during regeneration.

In FIGS. 6, 7, the electrodes inside the canister 60 are in the form of separate concentric cylinders. As far as the treatment of the passing water is concerned, the treatment is the same as in FIG. 4, in which the electrodes were spiral-wrapped.

In FIG. 4, it was unavoidable that all the positively-charged electrodes must be at the same voltage; in FIGS. 6, 7, the electrodes are insulated from each other, and the option now arises that the different electrodes can be at different voltages. In FIG. 6, the manner of potting the axial ends of the electrodes is different from FIG. 4, in that in FIG. 6, rings 76 of insulative potting material separate concentric rings 78 of conductive potting material. The several tubular electrodes are provided with respective terminal posts 80, connected to the current-collectors of the respective concentric electrodes. That being so, the arrangement is flexible as to how electrical power is, or might be, supplied to the electrodes: in series for example, or in parallel, or in a combination.

FIG. 8 shows several treatment-tubes 81, arranged side by side in the canister 60. Each tube is of small diameter, and the tube-wall contains only one or two pairs of electrodes. In this arrangement, the single common outer-plenum 83 supplies water to all the treatment-tubes. In FIG. 8, the treated water emerges into the respective interiors of the tubes, and the inner-plenum now includes those interiors and a common outlet conduit with which those interiors connect.

The design of the plenums preferably should be such as to reduce or eliminate pressure gradients and differences, such that every drop of water in the plenum is at the same hydraulic pressure (apart from the effects of gravity).

The scope of the patent protection sought herein is defined by the accompanying claims. The apparatuses and procedures shown in the accompanying drawings and described herein are examples.

Some of the physical features of the apparatuses depicted herein have been depicted in just one apparatus. Not all options have been depicted of all the variants. Skilled designers should understand the intent that depicted features can be included or substituted optionally in others of the depicted apparatuses, where that is possible.

Terms of orientation (e.g “upper/lower” and the like) when used herein are intended to be construed as follows. The terms being applied to a device, that device is distinguished by the terms of orientation only if there is not one single orientation into which the device, or an image (including a mirror image) of the device, could be placed, in which the terms could be applied consistently.

Terms used herein, such as “cylindrical”, “concentric”, and the like, which define respective theoretical constructs, are intended to be construed according to the purposive construction.

A reference to a component being “integrated rigidly into” another component means, herein, that the two components are either formed from one common piece of material, or, if formed separately, are fixed together so firmly and rigidly as to be functionally and operationally equivalent to having been formed from one common piece of material.

The scope of the patent protection sought herein is defined by the accompanying claims. The apparatuses and procedures shown in the accompanying drawings and described herein are examples.

The numerals that appear in the drawings are:
20 water treatment apparatus
21 treatment-tube
23 cylindrical tube-walls
25a, 25b electrodes
29 spacer
30 plastic container
32 inlet port
34 annular outer-plenum
36 inner-plenum
38 outlet-port
40 arrows indicating movement of water
43 tube-former
45a, 45b two electrodes
47 storage tank for value-water
49a, 49b two spacers
50 spiral-wrap sub-assembly
52a, 52b current-collectors, having . . .
54a, 54b respective protruding portions
56a, 56b insulative caps
60 canister housing
63 O-ring seals
65a, 65b outlet ports
67a, 67b conductive caps
69a, 69b cover-plates
70a, 70b flow-control valves
72 pump
74 electrical controller
76 insulative rings
78 conductive rings
80 terminal posts
81 many small-diameter treatment tubes
83 common outer plenum

1. Capacitive deionization treatment apparatus, wherein:
and a tubular axis;
the apparatus includes an outer plenum located outside the tube-wall, and an inner plenum located inside the tube-wall;
the apparatus includes an inlet-port, for conducting water to be treated into one of the plenums;
the apparatus includes an outlet-port, for conducting treated water out of the other plenum;
the tube-wall is of composite structure, in that the tube-wall includes a pair of electrodes, arranged as an outer electrode and an inner electrode;
the apparatus includes a power supply, which is capable of charging the electrodes with opposite polarity;
the electrodes include respective thin sheets of conductive material;
the electrodes are so arranged that capacitive-portions thereof lie in such close-spaced face-to-face overlapping relationship as to form a capacitive deionization (CDI) cell;
the capacitive-portions of the electrodes that lie in that relationship define a perimeter and a thickness of a capacitive-space located between the inner and outer electrodes;
the capacitive-space is defined as to its thickness by the face-to-face separation distance between the electrodes;
the capacitive-space is defined as to its perimeter in that, outside the perimeter of the capacitive-space, the electrodes are either curtailed, or the face-to-face separation distance between the electrodes is too large for substantive capacitive deionization to take place;
the material of the electrodes is a high-surface-area material;
the material of the electrodes is permeable, in that water can penetrate and flow through the materials thickness-wise, right through the thicknesses of the electrodes;
the apparatus is so structured and arranged as to be capable of being operated in a purification-phase and in a regeneration-phase;
the apparatus includes a controller that is effective to switch between the two phases;
in the purification-phase, the controller is effective, in respect of substantially the whole area enclosed by the perimeter of the capacitive-space:
(a) to convey water from one of the plenums thickness-wise through the tube-wall, wherein the water passes thickness-wise through one of the electrodes, then thickness-wise through the capacitive-space, then thickness-wise through the other electrode, and then into the other plenum;
(b) to convey electrical energy to the electrodes at a voltage that is (i) high enough to create a substantive capacitive effect between the electrodes, and (ii) low enough to avoid creating electrolytic redox reactions in water passing through the treatment-tube, and
(c) to remove ions from the water by electrostatic attraction, whereby the ions become sorbed into the electrodes;
in the regeneration-phase, the controller is effective:
(a) to cause regen-water to pass through the capacitive-space, and
(b) to cause ions to be transferred from the electrodes into the passing regen-water.

2. Apparatus of claim 1, wherein, in the regeneration-phase, the controller is effective to cause the electrodes to be electrically-shorted.

3. Apparatus of claim 1, wherein, during the purification-phase, the water to be purified flows radially inwards, in that the controller is effective to direct the flow of water:
from the inlet port to the outer plenum;
then thickness-wise through the outer electrode;
then thickness-wise through the capacitive-space;
then thickness-wise through the inner electrode;
then into the inner plenum; and
then out through the outlet-port.

4. Apparatus of claim 3, wherein, during the regen-phase, regen-water flows radially inwards, in that the controller is effective to direct the flow of regen-water:
from the inlet port to the outer plenum;
then through the outer electrode;
then through the capacitive-space;
then through the inner electrode;
then into the inner plenum; and
then out through the outlet-port.

5. Apparatus of claim 3, wherein, during the regen-phase, regen-water flows radially outwards, in that the controller is effective to direct the flow of regen-water:
from the inlet port to the inner plenum;
then through the inner electrode;
then through the capacitive-space;
then through the outer electrode;
then into the outer plenum; and
then out through the outlet-port.

6. Apparatus of claim 1, wherein:
the apparatus includes a spacer, which is:
of non-conductive material, in the form of a thin sheet or film;
positioned between the two electrodes;
effective to keep the two electrodes separated electrically; and
permeable to the movement of water therethrough.

7. Apparatus of claim 6, wherein the spacer is so thin that, in the capacitive-space, the spacer holds the two electrodes no more than 250 microns apart.

8. Apparatus of claim 1, wherein:
the outer plenum, located outside the tube-wall, is so sized and arranged that substantially no differences or gradients of hydraulic pressure exist therein, except as dictated by gravity; and
the inner plenum, located inside the tube-wall, is so sized and arranged that substantially no differences or gradients of hydraulic pressure exist therein, except as dictated by gravity.

9. Apparatus of claim 1, wherein:
a sub-assembly of the apparatus includes the two electrodes intercalated with two spacers and spirally wrapped around a tube-former;
the tube-former is permeable to the flow of water through the walls thereof, and the inner plenum is located inside the tube-former;
the sub-assembly is located inside a canister, and the outer plenum is located outside the sub-assembly and inside the walls of the canister.

10. Apparatus of claim 1, wherein the tube-wall includes many of the electrodes, arranged in concentric circles.

11. Apparatus of claim 10, wherein:
the said treatment-tube is termed a first treatment-tube;
the apparatus includes several more treatment-tubes, in respect of each of which the tube-wall includes a pair of electrodes arranged as an outer electrode and an inner electrode;
the first and the several treatment-tubes are all located side-by-side inside a canister;
the outer-plenum of the apparatus is located inside the walls of the canister, and is common to all the treatment-tubes;
the respective inner plenums of the first and several treatment-tubes apparatus are connected together to form a common inner plenum of the apparatus.

12. Apparatus of claim 1, wherein the material of the electrodes is highly porous, having a capacitive surface area of at least 100 sq.m/gram.

13. Apparatus of claim 1, wherein the material of the electrodes has an intrinsic permeability of one darcy or more.

14. Apparatus of claim 6, wherein the permeability of the spacer is double the permeability of the electrodes, or more.

15. Apparatus of claim 1, wherein the power-supply and controller are effective to supply electrical energy to the electrodes at a voltage between 1.2 and 1.6 volts.

16. Apparatus of claim 6, wherein the spacer is 250 microns thick or less.

17. Procedure for purifying water contaminated with a salt, including:
providing the apparatus of claim 1;
in the purification-phase, supplying the water to be purified to the inlet-port of the apparatus, and conducting purified value-water away from the outlet-port;
in the regeneration-phase, supplying regen water to the inlet-port, and conducting concentratedly-contaminated water away from the outlet-port;
operating the apparatus in the manner of a capacitive-deionization (CDI) cell;
including operating the controller as to switch the apparatus back and forth cyclically between the purification phase and the regeneration-phase;
including switching the apparatus from the purification-phase to the regen-phase in dependence upon the capacitor becoming fully, or nearly-fully, charged; and
including switching the apparatus from the regen-phase to the purification-phase in dependence upon the capacitor becoming fully, or nearly-fully, discharged.

18. As in claim 1, wherein, in the purification-phase, the controller is effective, in respect of substantially the whole area enclosed by the perimeter of the capacitive-space, to convey the water thickness-wise through the capacitive-space in a direction that is substantially straight across the capacitive-space.
